(19) United States
(12) Patent Application Publication
(10) Pub. No.: US 2014/0375453 A1
(43) Pub. Date: Dec. 25, 2014

(54) System for Detecting an Intrusion Attempt Inside a Perimeter Defined by a Fence

(71) Applicant: Inoxys S.A., Petange (LU)

(72) Inventor: Thierry Chamoux, Petange (LU)

(21) Appl. No.: 14/374,480

(22) PCT Filed: Jan. 24, 2013
(86) PCT No.: PCT/EP2013/051294

§ 371 Date: Jul. 24, 2014

(30) Foreign Application Priority Data
Jan. 24, 2012 (FR) 1250675

(51) Int. Cl. G08B 13/02; G08B 15/00

(52) U.S. Cl. CPC G08B 13/02; G08B 15/005
USPC 340/541

(57) ABSTRACT

The present invention relates to a system for detecting an intrusion attempt inside a perimeter defined by a fence including panels attached onto posts, comprising a means for detecting shocks and/or vibrations (4), which is connected to a remote station (7). Said system is characterized in that it comprises at least one housing (1) including at least one central processing unit or CPU (2), which is connected to at least one memory unit (3), to at least one shock and/or vibration detector (4), and to at least one field bus (5, 6) and/or at least one video bus (27, 28), each housing (1) being self-contained and connected to another housing (1) and/or to at least one remote station (102) for transmitting at least one computer file generated by the central processing unit (2) when a shock and/or vibrations are detected by one of the housings (1). DRAWING: FIG. 1: 3a RAM Memory 3b Flash Memory 3c ROM Memory 3d EPROM Memory 4 Gravitometer/accelerometer sensor 5 Field bus 6 Calendar clock 7 Clock synchronization 8 Temperature sensor 9 Cable tension sensor 10 Cable strength sensor 11 Internal or external physical measurement sensors: Radioactivity Flow rate Pressure Temperature Hygrometry 12 Added functional bus

### TECHNICAL AREA

This operation concerns perimeter protection of sensitive sites, and more specifically an intrusion attempt detection system, within a perimeter limited by a fence system of the type comprising panels fixed to posts, with impact and/or vibration detection, connected to a remote station.

### PREVIOUS TECHNOLOGIES

In the field of the border protection of sensitive sites, such as military bases, warehouses or company offices, for example, different systems are well documented for detecting the unauthorised presence of individuals around a zone limited by a fence and/or for detecting attempted intrusion within that perimeter.

The most common systems involve infrared detectors connected to a remote alarm station. In such systems, infrared detectors form a network, limiting the perimeter to be protected. When a person crosses that perimeter, the infrared beam is temporarily broken, triggering an alarm signal.

This type of system cannot be used for monitoring a large outdoor area, to the extent that numerous animals or insects tend to cut the infrared beam, thus triggering a large number of unnecessary alarms.

We are also aware of surveillance systems comprising hyper-frequency modules connected to a remote central station which emits waves in the area to be protected. The presence of an individual in one of these zones disrupts the waves, and detection triggers an alarm signal.

In the same way as above, this type of system cannot be used to monitor a large, outdoor area, to the extent that numerous animals or insects tend to disrupt the waves, thus triggering a large number of unnecessary alarms.

However, these systems are primarily used to detect unauthorised presence of an individual within a determined perimeter, and not to physically prevent people from entering the said perimeter. Thus, these systems are often used as an addition to a fence, which usually comprises panels, such as “woven” or welded metal wire panels, chain link fence metal wire panels, or wire mesh panels, for example, fixed to posts limiting the border.

So as to get around these disadvantages, using vibration as a means of detection has already been tested, as well as impact detection units fitted to fencing panels. These means of detection generally involve accelerometers, or used in systems habitually covered by the term “shock cable” [cable choc], comprising a pair of conducting wires designed to emit a signal in case of vibration and/or impact on panels and/or posts.

This is in particular the case of American patent n° U.S. Pat. No. 3,803,548 in particular, which describes an alarm system for an anti-intrusion fence. The said system comprises an element of piezo-electric movement detectors fixed to the posts of the fence and connected to a central detection unit, and a probe cable fitted to the fence panels at regular interviews, and connected to a second electronic detection module. All these alarm systems present the disadvantage of requiring great lengths of electrical cables, and particularly in the case of a very long perimeter fence, and surveillance cameras along the perimeter, which substantially increases the installation costs of such alarm systems.

Also, it is easy to detect “shock cables” and to neutralise them by cutting wires, so that these alarm systems are not very effective.

### PRESENTATION OF THE INVENTION

One of the objectives of the invention, therefore, is to get around these disadvantages by proposing an intrusion attempt detection system on a fence or on wall panelling, or a detection system of attacks on sensitive infrastructure, pipelines, gas lines, cables, and possibly allowing easy video surveillance functions, along with access control, technical surveillance of industrial processes and fire/major risk safety.

To this end, and in compliance with the invention, an intrusion attempt detection system is proposed inside a perimeter limited by a fence type barrier comprising panels fixed to posts, including impact and/or vibration detection systems, and connected to a remote station. The said system is remarkable in that it comprises at least one box containing at least a central processing unit (CPU) connected to at least one memory unit, at least one impact and/or vibration detector, and at least one fieldbus, and/or at least one video bus, each box being autonomous and connected to another box, and/or at least to a remote station to transmit at least one data file generated by the central processing unit when an impact and/or vibration is detected by one of the boxes.

The advantage of the system is that it comprises at least one camera connected to one of the inputs of a box, the said camera being triggered by the central processing unit, when the said central processing unit detects an impact and/or vibration to create a photo and/or a video sequence which is recorded in the memory unit and then transmitted to the remote station.

The said camera comprises lighting aids that are activated by the central processing unit when an impact and/or vibration is detected.

These lighting aids comprise infrared electroluminescent diodes.

The advantage of the system is that the earth of the video cable and the earth of the camera power cable are connected to one of the outputs of the box, so as to allow the central processing unit to pilot the activation of lighting.

Another advantage is that the said central processing unit contains the means to analyse the images captured at regular intervals by the camera(s) connected to the said box, so as to determine whether a movement has taken place within the field of vision of the camera. The central processing unit generates a warning file, which is sent to the central station if movement is detected.

The said impact and/or vibration detection device comprises at least one accelerometer, for example.

Furthermore, each box is fitted to a panel and/or a post of the fence, and the system can comprise a number of boxes connected in series, with the advantage of each box being watertight.

### SUMMARY DESCRIPTION OF FIGURES

Other advantages and characteristics will be demonstrated better by the description that follows, of a single design alternative given as a non-exhaustive example of an intrusion attempt detection system inside a perimeter limited by a barrier according to the invention, in reference to the drawings appended, upon which:

FIG. 1 is a diagram of an intrusion attempt detection system box, inside a perimeter limited by a fence,

FIG. 2 is a diagram of a design alternative of an intrusion attempt detection system box inside a perimeter limited by a fence,

FIG. 3 is a diagram of another design alternative of an intrusion attempt detection system box inside a perimeter limited by a fence,

FIG. 4 diagram of another design alternative of an intrusion attempt detection system box inside a perimeter limited by a fence,

FIG. 5 is a diagram of an intrusion attempt detection system inside a perimeter limited by a fence and comprising several boxes according to the invention,

FIG. 6 is a diagram of a design alternative of an intrusion attempt detection system inside a perimeter limited by a fence and comprising several boxes according to the invention,

FIGS. 7A and 7C are diagrams of intrusion detection, in comparison to measurements of several detection boxes positioned at regular intervals on the panels of a fence,

FIG. 8 is a diagram of a semi-rigid fence comprising regularly-spaced posts and wire mesh in a single taut section,

FIG. 9 is a diagram of a gate comprising a frame and taut wire mesh on the said frame,

FIG. 10 is a diagram of a pedestrian gate comprising a frame and taut wire mesh on the said frame

FIG. 11 is a diagram of another design alternative of an intrusion attempt detection system inside a perimeter limited by a fence comprising several boxes according to the invention.

### DETAILED DESCRIPTION OF THE INVENTION

For reasons of clarity, further to the description, the same elements have been identified by the same figure references. Furthermore, the different views are not necessarily drawn to scale, and the dimensions of the elements may have been enlarged to make understanding of the invention easier.

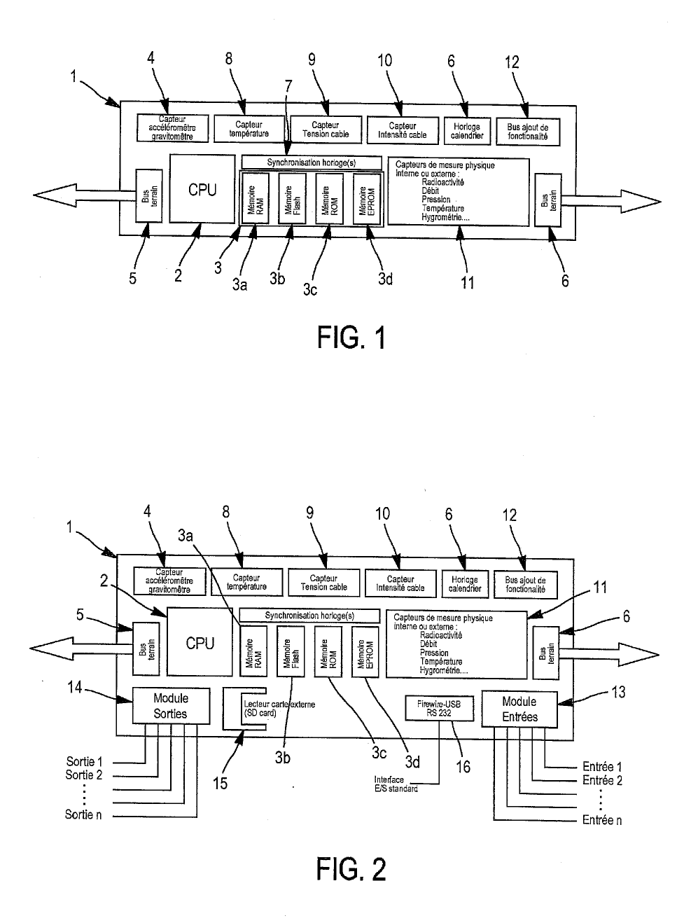

With reference to FIG. 1, the intrusion attempt detection system, according to the invention, comprises several boxes (1), which present the advantage of being watertight and attached by all appropriate means to a post and/or a panel of a fence, as detailed below.

The panels can be of different rigid or flexible types, such as, in particular, welded panels, woven metal wire panels, welded metal wire panels, panels with so-called chain link fence metal wire panels, taut wire mesh panels, etc.

Each box (1) comprises a central processing unit (CPU) (2), such as a microprocessor, for example, connected to at least one memory unit (3), to at least one impact and/or vibration detector (4) and to two fieldbuses (5) and (6), each box (1) being autonomous and connected to another box (1) and/or to a remote station comprising a PC type computer by an electric cable via fieldbus (5, 6).

The impact and/or vibration detector (4) comprises an accelerometer, preferably a capacitor type accelerometer. However, it is obvious that the impact and/or vibration detector (4) can take the form of any impact and/or vibration detector well known to the Profession without this taking it outside the frame of the invention.

Each box (1) is autonomous, and functions in the same way as a computer with its own operating system. The said operating system can be any known operating system, such as, for example, DOS, OS/2, GNU/Linux, Windows, NetBSD, FreeBSD, OpenBSD, etc. By operating system, we refer to all the central programmes of an IT unit which serves as an interface between the equipment and applications, or between middleware and IT equipment. The operating system also serves to coordinate the use of a microprocessor, i.e., the central processing unit (2), to tune the execution of each process for a given time to execute each process, to reserve memory space for the requirements of the programmes, and to organise the content of the mass memory or memories in files and directories.

Each box (1) is powered by a power source box which is connected either to the mains or to a solar panel, or to a battery.

In this specific installation example, the memory unit (3) of the box (1) comprises a RAM memory (3a) according to the Anglo-Saxon acronym “Random Access Memory”, an EEPROM type memory (3b) according to the Anglo-Saxon acronym “Electrically-Erasable Programmable Read-Only Memory” commonly called “flash” memory, a ROM type (3ç_) memory according to the Anglo-Saxon acronym “Read Only Memory” and as an accessory, an SRAM type memory (3d) according to the Anglo-Saxon acronym, “Static Random Access Memory”.

It is obvious that the memory unit can comprise one or more types of memory known to the Profession without taking it outside the frame of the invention.

Furthermore, it goes without saying that each box (1) can contain a single fieldbus (5) or (6) without taking it outside the frame of the invention.

Also, each box (1) comprises an internal clock (6) and clock synchronisation techniques (7) of the different boxes (1) forming a detection system according to the invention. As an accessory, each box (1) comprises a temperature probe (8), a voltage measurement detector (9) in the cable linking up the two boxes (1), an intensity measurement detector (1) of current in the cable linking up the two boxes (1), an internal or external physical measurement detector (1), allowing radioactivity, flows, temperature, hygrometry or other measurements to be made, as well as a bus (12) allowing new functionalities to be added to the said box (1). The voltage measurement detector (9) of the power cable transmits the power measurement to the central processing unit (2) which displays the said measurement on one of the remote stations, and compares this voltage measurement to predetermined voltage thresholds, a lower and/or upper threshold. When the voltage measured is higher than the upper predetermined voltage threshold, or lower than the predetermined voltage threshold, the central processing unit (2) generates an alarm message which is transmitted to at least one remote station.

When an impact is detected by the impact and/or vibration detector (4), the central processing unit (2) generates a computer file, including the date and time of the impact, as well as the position of the detector (4) having detected the impact and/or vibration. The computer file is then transmitted to the computer, which serves as a remote station in such a way that an alarm is sent to the said remote station. The said alarm can be in the form of a sound alarm, for example.

According to a first design alternative of the system, according to the invention, in reference to FIG. 2, each box (1) comprises, in the same way as previously described, a central processing unit CPU (2), such as a microprocessor, for example, connected to at least one memory unit (3), to at least one impact and/or vibration detector (4), and to two fieldbuses (5) and (6), each box (1) being autonomous and connected to another box (1) and/or to a remote station comprising a PC type computer via an electrical cable via fieldbuses (5, 6). Each box (I) also comprises an internal clock (6) and clock synchronisation technology (7) of the different boxes (1) forming the detection system according to the invention and, as an accessory, a temperature detector (8), a voltage measurement detector (9) in the cable connecting the two boxes (1), an intensity measurement detector (10) of current in the cable linking up the two boxes (1), an internal or external physical measurement detector (I I) allowing radioactivity, flows, radioactivity, temperature, hygrometry or other measurements to be made, as well as a bus (12) allowing new functionalities to be added to the said box (1).

The box (1) is different from the box previously described (1), as it comprises an input module (3), the said module comprising “n” inputs and an output module (4), the said module comprising “n” outputs. Thus, different units, such as a digicode keypad, a microphone, a bell or a door opening detector can be connected to the inputs (13) of each box (1) and units such as a magnetic lock, an electrical latch for the opening of a door or similar or a loudspeaker can be connected to the outputs (14) of the said box (1). In this way, an operator can manually trigger from any remote station any of the units connected to one of the outputs (14) of the boxes (1). Furthermore, a remote station (7) can automatically control the units connected to one of the outputs (14) of the boxes (1), according to information sent by the boxes (1) via one or more units connected to the inputs (13) of the said boxes (1), for example, door opening by activation of a magnetic lock on an electrical latch, having received the code entered on the digicode pad connected to an input (13) of a box (1). Other units, such as a biometric device or a movement detector can also be connected to the inputs (13) of the boxes (1), without taking it outside the frame of the invention.

Another advantage of the system is that the box (1) contains an SDRAM memory card reader (15) according to the Anglo-Saxon acronym “Synchronous Dynamic Random Access Memory” and an IEEE 1394 multiplexed series interface (16) such as that sold under reference FIREWIRE® RS 232 for example.

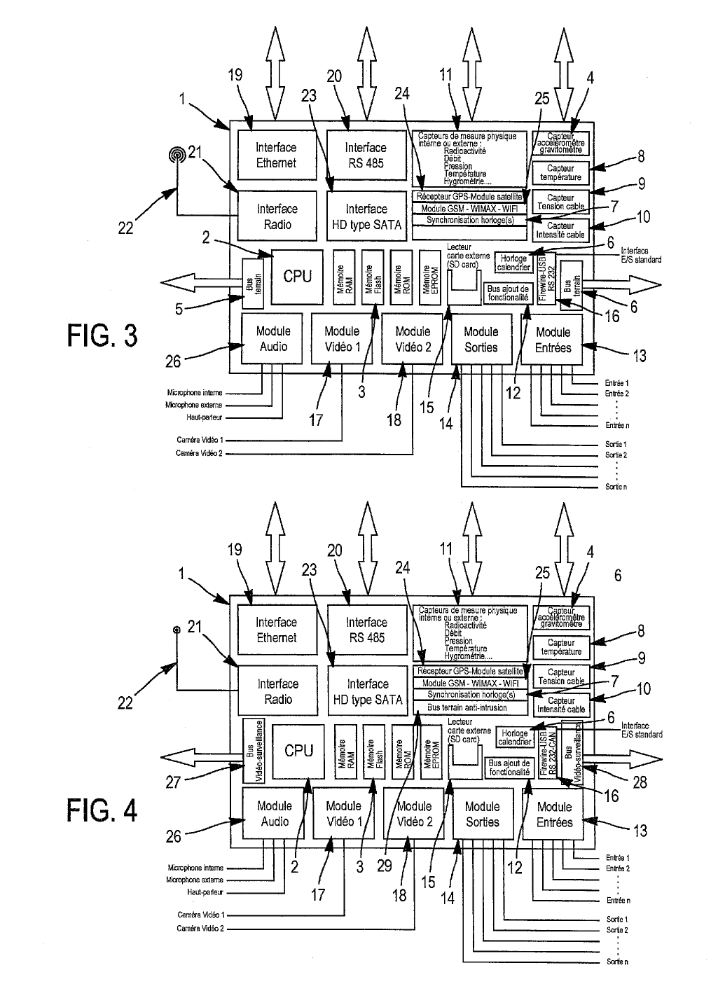

In reference to FIG. 3, according to another design alternative of the system according to the invention, each box (1) comprises in the same way as previously a central processing unit CPU (2), such as a microprocessor, for example, connected to at least one memory unit (3), to at least one impact and/or vibration detector (4) and to two fieldbuses (5) and (6), each box (1) being autonomous and connected to another box (1) and/or to a remote station (7) comprising a PC type computer, by electrical cable via the fieldbuses (5,6). Each box (1) also contains an internal clock (6) and clock synchronisation technologies (7) for the different boxes (1) comprising the detection system according to the invention and, as an accessory, a temperature detector (8), a voltage measurement detector (9) in the cable linking the two boxes, an intensity measurement detector (1) for current in the cable connecting the two boxes (1), an internal or external physical measurement detector (11) allowing radioactivity, flows, temperature, hygrometry or similar to be measured, as well as a bus (12) allowing new functionalities to be added to the said box (1), an input module (13), an output module (14), an SDRAM card reader (15) and an IEEE 1394 multiplex series interface (16) such as that sold under the reference FIREWIRE® RS 232 for example. The box (1) is different from the box (1) previously described, because it comprises two video modules (17, 18), each including a port. In this way, one or two cameras can be connected to the box (1). The said video module ports (17, 18) can receive CCD cameras which are automatically recognised and installed by the central processing unit (2) of the box (1). An advantage is that these cameras can contain lighting mechanisms such as electroluminescent diodes called, according to the Anglo-Saxon acronym, “Light Emitting Diode” or infrared LEDs. Thus, when an impact is detected by the impact and/or vibration detector (4), the central processing unit (2) activates the camera and records an image or a succession of images in the form of a picture file or a video file. Simultaneously, the central processing unit (2) generates an alarm data file including the date and time of the impact, as well as the position of the detector (4) that detected the impact and/or vibration. The alarm data file is then transmitted to the remote station computer in such a way that an alarm is emitted on the aforementioned remote station. The said alarm can comprise, for example, a sound alarm. Then the picture or video file recorded in the memory unit is displayed on the screen of the remote station.

It is obvious that several cameras can be connected to the box (1) and that a picture or video sequence can then be recorded by the box (1) when impact and/or vibration is detected. The image-capture mechanisms can be activated by a remote station.

Furthermore, it goes without saying that each box (1) can comprise just a video module (17) or (18) without putting it outside the frame of the invention.

Of further note is that lighting mechanisms for the cameras are not activated by the central processing unit (2) of the box (1) except when an impact and/or vibration is detected by the impact and/or vibration (4) detector of the said box (1), so as to avoid nocturnal insects attracted by the light coming in front of the camera lens.

It should also be noted that alternatively all the cameras can be on around the perimeter so as to secure images of each sector of the said perimeter to be protected. Since each camera switches from 100 mA to a little more than 1 A when the infrared LED comes on, and each camera takes 1/18^{th} of a second to take a picture, it is possible to have the 10 cameras working simultaneously in such a way that in one second, 100 cameras can have taken a picture whilst limiting electricity consumption, because the infrared LEDs on the cameras are only activated when a picture is captured by the said camera. In this way, the camera's infrared LEDs blink, and therefore do not work continuously, thus avoiding the problem of attracting nocturnal insects and consuming too much electricity. A particular advantage is that the said central processing unit (2) contains the technology to analyse the captured images at regular intervals by the camera or cameras connected to the said box (1) so as to determine whether a movement has taken place within the field of vision of the camera, the central processing unit (2) generating an alert file, which is then sent to the central station in case of movement detection. This technology involves an algorithm which compares the images captured by the camera at different moments, and determines any variation in pictures. A major variation in pixels in the determined area of the images is interpreted as an intrusion.

Also, in reference to FIG. 3, each box (1) also contains an Ethernet card (19) connected to a central processing unit (2) so as to allow the boxes to be connected up (1) on a so-called local network such as an Ethernet network, for example.

An advantage is that each box (1) also comprises an RS 485 interface (20), also called an EIA 485 interface, allowing “full duplex” or “half duplex” communications, and/or radio interface (21) linked to an antenna (22) or to an SATA-type HD interface (23) according to the Anglo-Saxon acronym “Serial Advanced Technology Attachment”.

Furthermore, each box (1) contains a GPS receiver (24) so as to geolocate the box in real time (1), a GSM module (25) to allow communications on the GSM network, and an audio module (26) containing inputs to which microphones can be connected and outputs to which loudspeakers can also be connected. In reference to FIG. 4, according to another design alternative of the system according to the invention, each box (1) comprises in the same way as previously a central processing unit (CPU) (2), such as a microprocessor, for example, connected to at least one memory unit, to at least one impact and/or vibration detector (4), each box (1) being autonomous and connected to another box (1) and/or to a remote station (7). Each box (1) also contains an internal clock (6) and clock synchronisation technologies (7) for the different boxes (1) comprising the detection system according to the invention and, as an accessory, a temperature detector (8), a voltage measurement detector (9) in the cable linking the two boxes, an intensity measurement detector (1) for current in the cable connecting the two boxes (1), an internal or external physical measurement detector (11) allowing radioactivity, flows, temperature, hygrometry or similar to be measured, as well as a bus (12) allowing new functionalities to be added to the said box (1), an input module (13), an output module (14), an SDRAM card reader (15) and an IEEE 1394 multiplex series interface (16) such as that sold under the reference FIREWIRE® RS 232 for example. The box (1) also comprises two video modules (17,18) respectively including a port, an Ethernet card (19), an RS 485 interface (20), also called an EIA 485 interface, allowing “full duplex” or “half duplex” communications, and/or a radio interface (21) linked to an antenna (22) and/or a SATA HD interface (23) according to the Anglo-Saxon acronym “Serial Advanced Technology Attachment”, a GPS receiver (24) so as to geolocate the box in real time (1), a GSM module (25) to allow communications on the GSM network, and an audio module (26).

The said box (1) is different from the box previously described (1), because the fieldbuses (5, 6) are replaced by video surveillance buses (27, 28) and because it comprises an anti-intrusion fieldbus (29).

It is obvious that the bus (1) can contain a single video bus (27) or (28) without this taking it outside the frame of the invention.

Preferably, each box (1) comprises independent alarm systems such as an LED type luminous alarm, a sound alarm comprising a loudspeaker, for example, which allows a sound or visual alarm to be emitted on the box (1) having detected an impact corresponding to an intrusion, independently of the alarm transmitted to the remote stations.

An advantage is that each box (1) and/or each remote station comprises a so-called “watch dog” mechanism which is well known to the Profession, allowing an alarm to be sent over the cable to the other remote stations, to signal that the box (1) being observed is blocked, and/or trigger a sound and/or visual alarm on the said blocked box (1). It is obvious that the box (1) can contain all appropriate means to allow connection to any network, such as a local network by broadband over power line (BPL), a WI-FI® or Zigbee® network, for example, without taking it outside the frame of the invention.

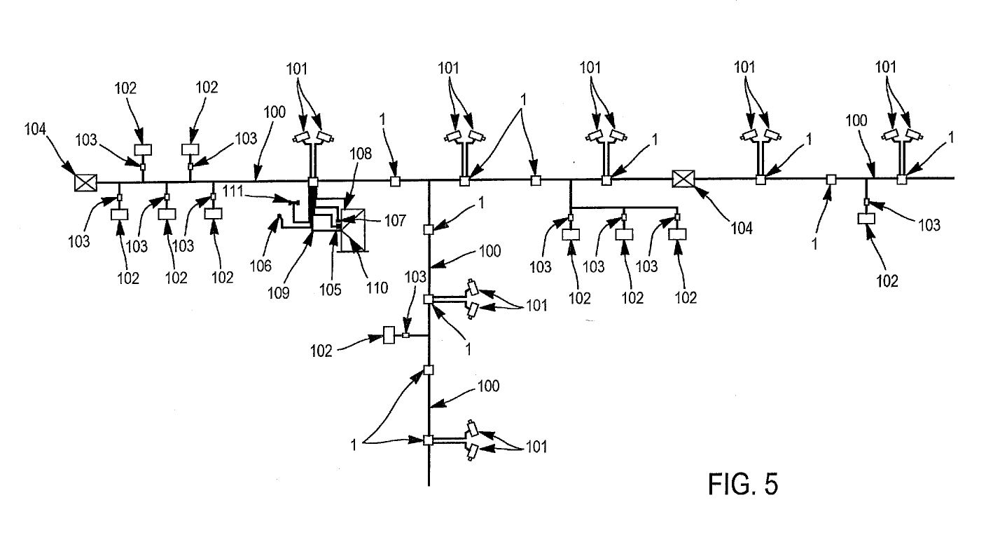

In reference to FIG. 5, the system comprises a number of boxes (1) connected in series by cables (100) such as coaxial cable, for example, which simultaneously electrically powers the boxes (1) and the different units connected to the said boxes (1) such as cameras (101) for example, and transmits data files generated by the central processing unit (2) to the remote station(s) (102). It should be noted that the latter are connected to the cables via a USB interface (103) which is well known to the Profession. Furthermore, power is provided by electrical supply boxes (104) which can be connected to the mains, to batteries or to solar panels, for example.

Note that the coaxial cables (100) allow data transmission even if they are cut, since the data transfer flow rate is lower for a cut coaxial cable compared to an uncut coaxial cable.

One of the boxes (1) comprises input modules, with the said modules comprising “n” inputs and an output module, the said module containing “n” outputs as described in FIGS. 2, 3 and 4. Thus, different units, such as a digicode keypad (105), a microphone (106), a bell (107) or a door opening detector (108) can be connected to the box inputs (1) and units such as a magnetic lock or an electrical latch (109) to open a door (110) or similar, or a loudspeaker (111) can be connected to the outputs of the said box (1). In this way, an operator can, from any remote station, manually trigger any of the units connected to one of the box outputs (1). Furthermore, a remote station (102) can automatically control units connected to one of the box outputs (1) according to information sent by the boxes (1) via one or more units connected to the said box inputs (1), for example, the opening of a door by triggering the magnetic lock of an electric latch, having received the code entered on the digicode keypad connected to the input of a box (1).

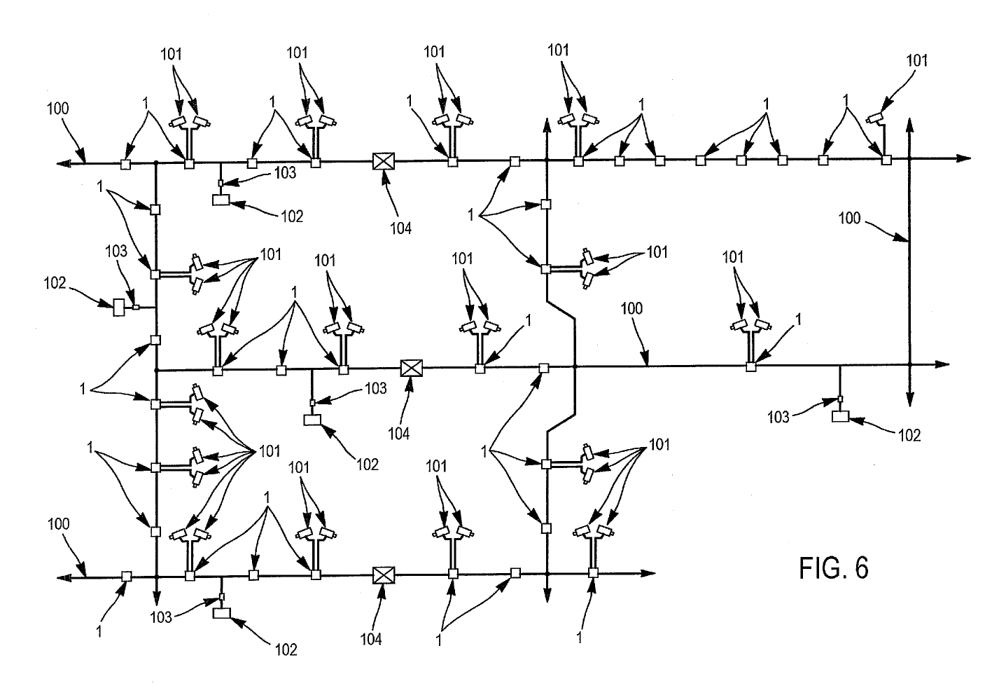

An advantage is that each box (1) can contain programmes, in particular allowing a box (1) located near a door to send a script so that a contiguous box (1) to which a camera covering the zone of the first box is connected takes a photo or an image when the first box (1) has detected an entry via the door and/or an impact. The image taken by the second box is then transmitted to the remote stations (7). When a box (1) detects a vibration, the said box (1) compares the measurement of several other contiguous boxes or uses an anemometer connected to a contiguous box to differentiate gusts of wind. In reference to FIG. 6, according to a design alternative of an intrusion detection system according to the invention, the system comprises so-called nested loops. To this end, on the fieldbus, between the two boxes (1), the buses are branched. Note that bus branches can be of unlimited length. When an impact or a vibration is measured by a box (1), positioned on such a branch, the return to the branch's initial bus generates echoes of the said impact or vibrations measured by the boxes of the loop located on the bus. The boxes (1) filter these echoes to create nested loops of any level, length or quantity. Such a configuration produces a redundancy of buses. Furthermore, in case of a bus cut on any segment, all the boxes remain operational and can transmit measurements to any remote station (102).

The comparison of measurements performed by the different boxes (1) allows discrimination of signals to be performed when they are generated by wind or to indicate the extent of an intrusion in the case of a fence being impacted by a car or a truck, for example.

Also, the comparison of the boxes' internal clocks allows direction and speed of propagation of vibrations on the fence to be given.

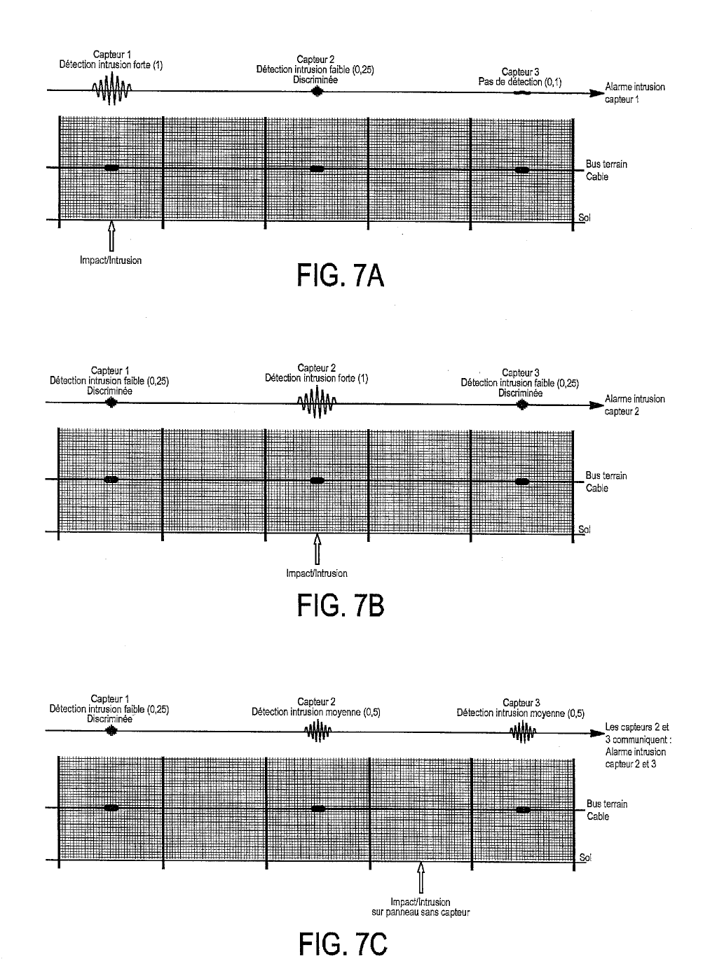

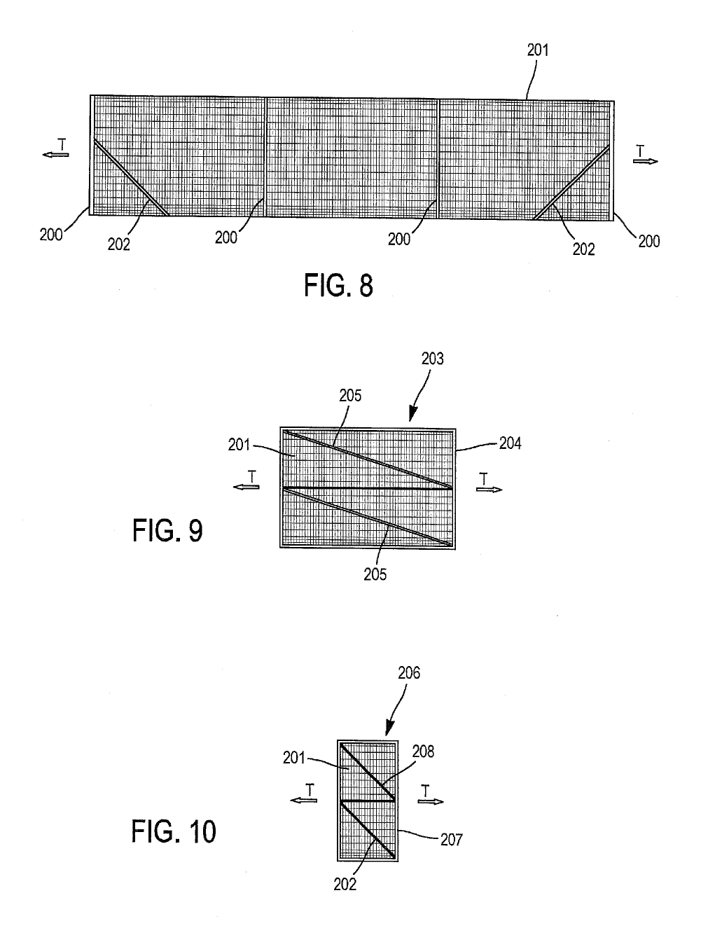

In reference to FIGS. 5, 6 and 7A to 7C, the boxes (1) communicate between each other via a fieldbus. When an impact, vibration or noise is detected by one of the boxes (1), the contiguous boxes (1) are interrogated. The comparison between all the signals transmitted by the boxes (1) gives additional useful information. In reference to FIGS. 7A and 7B, when there is an impact on a panel of the fence where a box is fixed (1), it transpires that the boxes (1) measure lower vibrations than those of the first box (1), so that the latter are differentiated for the location of the impact on the fence. In reference to FIG. 7C, when an impact occurs on a panel of the fence which does not contain a box (1), it transpires that the boxes (1) closest to the impact measure the almost equal vibrations, and the boxes most distant from the impacts only measure very low vibrations. The measurements of boxes (1) closest to the impact are therefore used to determine the position of the impact on the fence, whilst the other more distant box measurements (1) are differentiated out. In this way, it is possible to reduce the number of boxes (1) along the fence, and build the fence using regularly-spaced posts and a single stretch of mesh fencing. In reference to FIG. 8, the fence is made up of regularly spaced posts (200), and a semi-rigid mesh (201) in a single stretch with the posts (200) located at the ends equipped to electrify the mesh and the strengthening struts (202).

Also, in reference to FIG. 9, gate panels (203) of the fence comprise a more or less rectangular frame (204), on which a semi-rigid mesh is stretched (201), and the frame also comprises strengthening struts (205).

In a similar way, in reference to FIG. 10, pedestrian gates (206) along the fence comprise a more or less rectangular frame (207), on which a semi-rigid mesh is stretched (201), and the frame also comprises strengthening struts (208).

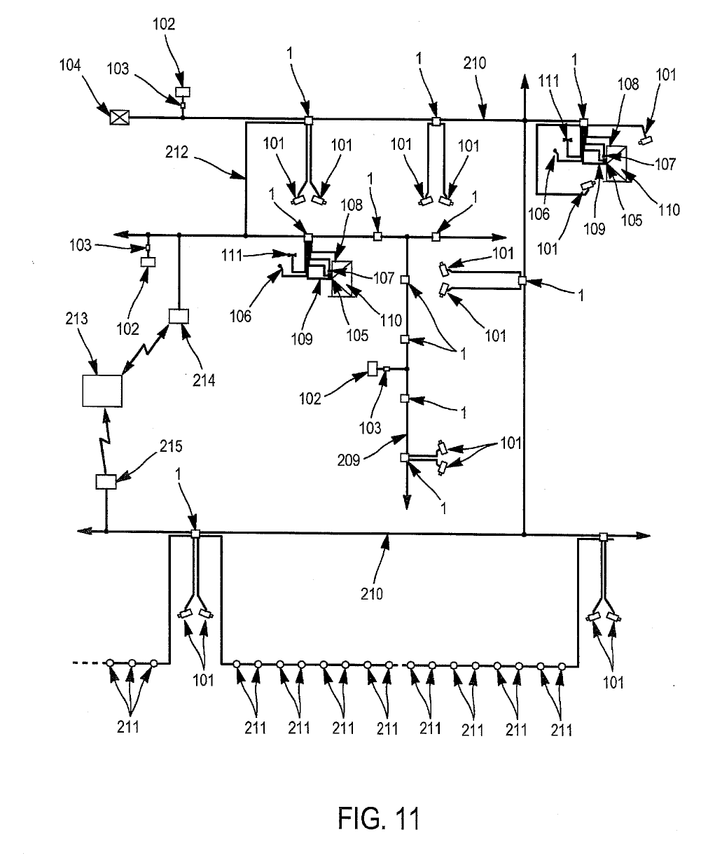

According to another design alternative of the system according to the invention, in reference to FIG. 11, the system comprises two independent networks, one network (209) comprising boxes (1) linked up by a cable for the box fieldbus (1) as described in FIGS. 1 to 3, and a second network (210) comprising boxes (1) connected up by a cable for the boxes' video bus (1) as described in FIG. 4. On each of these networks (209, 210), boxes (1) are fitted in series, and can receive different units, such as a digicode keypad (105), a microphone (106), a bell (107) or a door opening detector connected to the box inputs (1), units such as a magnetic lock or an electronic latch (108), to open a door (109) or similar, and a loudspeaker (110), and connected to the said box (1) outputs, cameras (101), detectors (211) mounted in series, for example, or any other unit. Each network (209, 210) also comprises one or more remote stations (102) connected to the cable via a USB interface (103).

An advantage is that the system, according to the invention, comprises a fieldbus cable (212) linking up a bridge between the fieldbus and the video bus of the two networks, as well as a so-called off site station (213) which can communicate with the central bridge box/fieldbus (214) connected to a cable for the network's fieldbus (209) and/or with a central bridge box/video bus (215) connected to the cable for the network's video bus (210).

Also, the system according to the invention allows the detection and location of explosions inside or near to the perimeter limited by the fence equipped with boxes (1) according to the invention, as well as the detection and location of shouting, as well as differentiation of tyre noise, which is particularly useful in a car park, the coupling of pictures and the triggering of events and movement detection by stereoscopy or stereovideo in particular. The detection and location of explosions is performed by the measurement of sounds by at least two boxes (1) both equipped with a microphone, the boxes (1) with perfectly synchronised internal clocks, and then by triangulation, the position of the sound source is determined either by a remote station (7) or by one of the boxes (1) which performs a triangulation algorithm on the basis of the sounds recorded, and more particularly of their duration, intensity, and time of detection. Explosion or firearms discharge detection and location is particularly beneficial for securing military camps during outdoor operations (OPEX), but also chemical and petrochemical industrial sites.

The detection and location of shouting is performed in the same way as the detection and location of explosions, with tyre noise being differentiated out, as long as the sound detected is located on a pre-defined road section, for example.

Also of note is the precision of sound location, whether an explosion, a firearms discharge, a shout or tyre noise will depend primarily on the synchronisation precision of the box's internal clocks (1) in the system.

On an accessory point, each box (1) can comprise a radio receiver not represented in the figures, so as to allow a person using a radio or mobile phone within the secured section or near to it to be located by a well-known triangulation process. An advantage of this is that when an intrusion or a particular event is detected by at least one box (1), a witness image is compared with at least one image captured by one of the boxes (1), covering the zone corresponding to the location and the intrusion or the event. The said witness image and the image(s) captured are visualised on the screen of at least one remote station (102).

Movement detection by stereoscopy or stereovideo, and calibration, are performed, in a way known to the Profession, by at least two boxes (1) on which at least one camera is connected, respectively.

We would remind you here of all the advantages of the functions of the system according to the invention, which are procured by algorithms performed by the said central processing unit of one or several boxes (1), and/or by several remote stations (102).

Dispelling Doubt by Photo

The system comprises at least one video camera (101), a camera or any other mechanism for recording images connected to one of the inputs of a box (1) with that device being triggered by a central processing unit when the said central processing unit detects an impact and/or vibration and/or other reason for an alarm trigger to capture a photo and/or a video sequence which is recorded in the memory unit and then transmitted to the remote station.

Memorising Events

An advantage is that the system can stock events, dates, times and/or video and/or image and/or sound files in the memory bank of one or more boxes (1). An advantage is that the system can regularly take photos or videos, and store them for a predefined period, so that when an event occurs, the system allows the photos or videos from before the event to be viewed.

Alarm and Dispelling Doubt by Audio

An advantage is that the system can comprise at least one microphone (106) connected to one of the box inputs for on-site listening, allowing the camera to be triggered (101) and an alarm to be generated when a threshold is passed, allowing noises, such as, for example, detonation, human shouting or the sound of an engine to be analysed.

Communication Between Boxes

An advantage is that the boxes (1) can communicate with each other via a fieldbus (5, 6), allowing, for example:

triangulation of sound events such as fire arms discharge, explosion, vehicle or miscellaneous noises.

The comparison of results between boxes close to each other to, for example, differentiate out events triggered by gusts of wind.

when an alarm is triggered by a box (1), the photo is taken by another box (1) containing a camera (101) which is better placed, and/or the activation of a video camera (101) on the video surveillance bus will be requested.

Programming

An advantage is that the system can comprise at least one programme called a script in the box memory (1) which is loaded or modified by a user from one or more remote stations (102) allowing the different elements of the box to inter-react (1), or the different elements of other boxes (1) present on the fieldbus (5, 6) and/or video.

Triggering of an External Event—Input

An advantage is that the system can comprise at least one input on the box (1), allowing information to be received from outside, like a limit switch or infrared barrier contact, so as, for example, to generate an alarm to send information to another box (1) on the network or to query another box (1).

Activator—Output

An advantage is that the system comprises at least one box output (1), allowing exterior devices from the box (1) to be powered or triggered, such as electric latch, scatter lamp, barrier electrification, motorised lock, electric gate, a digicode keypad, etc. The output is triggered by the user on a remote station (102) and/or from the box programme (1) and/or either from the box script (1) and/or from any other box present on the fieldbus (5, 6).

Remote Programming

An advantage is that the system can accept the update of all or part of the internal programmes inside a box, or all the boxes on the network, allowing an overall update of the network, or else a specific programming change of a specific box on the network. The former update is kept in memory to recall former status in case of dysfunction, for example. New programmes can be implemented via the fieldbus, each box on the system receiving and transmitting update information to the next.

Nested Loops

An advantage is, the system can contain a fieldbus (5, 6) and/or video allowing loops and nested loops for communication between boxes to be performed (1), and for them to be supplied with energy, since the realisation of nested loops also allows system redundancy on several levels if necessary.

Date and Time

An advantage is that the system can comprise at least one clock, allowing events to be dated. Triangulation

An advantage is that the system can comprise a synchronisation of box clocks (1) present on the fieldbus (5, 6). This function allows triangulation of no-limit events in particular. An advantage is that the system does not limit the length of the fieldbus (5, 6) and/or the video, the number of boxes (1), the number of remote stations (102) or the number of loops or nested loops.

Audio Output

An advantage is that the system comprises at least one box output (1), allowing sound and/or voice from one or more remote stations to be transmitted (102).

Watchdog

An advantage is that the system can comprise at least one watchdog system. “Watchdog” refers to software used to ensure that a computer does not remain blocked at a particular stage of processing in progress. This protection is generally designed to restart the system if a defined action is not executed within a given time lapse. Generally, this is performed by a regularly-zeroed counter. If the counter exceeds a given value (timeout), then the system resets (restart). The watchdog often involves a register updated via a regular interruption. It can also involve an interruption routine which must perform certain maintenance tasks before handing back to the main programme. If a routine goes into an infinite loop, the watchdog counter will no longer be zeroed, and a reset is ordered. The watchdog also means a restart can be performed if no such instruction is given. It just requires a value exceeding the capacity of the counter to be entered directly into the register: the watchdog will do the rest.

Power Voltage on the Fieldbus

An advantage is that the system can comprise at least one voltage detector on the box (1), which allows electrical voltage at this point of the fieldbus to be measured (5,6) so as, amongst other things, to check that the box and the devices attached to it are properly and regularly supplied with power (1). Exceeding the high and/or low threshold generates technical alarms. An advantage is that measurements at regular time intervals can be recorded in the box (1) so as to analyse power delivery performance at that point.

Detectors

An advantage is that the system can comprise at least one internal physical measurement detector (8, 11) or one external physical measurement detector (211) per box (1), allowing real time measurements to be performed or to store measurement data files. The box (1) itself can use the data via its programme and/or its script, and/or transfer it to one or more remote workstations (102).

Power Supply

An advantage is that the system can comprise at least one power box (104) which manages the power delivery to boxes (1). This power box (104) can be added anywhere on the bus (5, 6) so as to increase energy or power.

Movement Detection

An advantage is that the system can comprise at least one camera (101) connected to one of the inputs of the box (1). Analysis of the image generated by the said camera is performed by the box itself, and a modification of a certain number of pixels will lead to the triggering of an alarm.

Management of Cable Sectioning and Short Circuits

An advantage is that the boxes (1) are able to isolate a cable sectioning and continue to function, as long as they are connected to at least one portion of valid cable. The sectioning of cable can beneficially be considered as an attempted attack, and therefore generate an alarm.

Comparison of Images

An advantage is that the boxes (1) can process video images internally. The box (1) analyses the image(s) from the two video cameras in real time (101). This can be from cameras (101) connected directly to the box (1) or cameras connected to other boxes (1). This stereoscopic analysis allows objects in space to be measured, and therefore differentiate an alarm depending on the size of the object moving within the camera's field of vision. Stereoscopic analysis can be used, both for pictures and video streams.

Management of Infrared Lighting Power

An advantage is that the boxes (1) can manage nocturnal infrared lighting of cameras (101) both internally and externally. The fact of using lighting only when an image is captured delivers substantial energy savings. Furthermore, static lighting attracts insects and other flying bugs. The fact of having light that blinks or twinkles means insects are not attracted to the camera (101), thereby making nocturnal movement detection unusable. An advantage is that IR lighting of cameras (101) can be controlled by one wire of the power cable, the other carrying power and the earth being common with that of the video camera cable.

Installation on a Semi-Rigid Fence

An advantage is that the boxes (1) for impact and vibration detection can be installed on a semi-rigid type fence, a fence whose mesh (201) is strung with sufficient tension so that the mesh (201) holds up vertically between two rigid elements, i.e., posts (200), which maintain the tension. This sort of fence behaves as a piano string between two elements maintaining tension, which reduces the number of boxes required (1) on a given length in spite of the presence of intermediary support elements, i.e., other posts (200. Tension T can also be maintained by properly sizing the posts (200) in connection to the type of nesting or by substituting this element by a rigid structure such as a wall or building post, for example. However, this list is not exhaustive. If gates and pedestrian gates are used in a semi-rigid fence, sold under the Draken® brand, for example, the mesh can be subject to sufficient T tension, which is applied between the uprights of each section.

Anemometer

An advantage is that one or more anenometers can be connected to boxes (1) so as to provide an indication of wind speed and direction, and the presence of gusts of wind. This allows detection sensitivity to be adjusted for all boxes (1) present on the fieldbus (5, 6).

Number of Detectors

An advantage is that a box can manage a large number of detectors linked up together. Surveillance of active electric cable

An advantage is that each box (1) can be equipped with a mechanism which measures the electrical activity inside the cable without necessarily being in contact with the cable, and/or without damaging that cable. This function allows an alarm to be generated when the cable is no longer active, and/or when undesirable activities take place to generate measurement or measurement dispatch data files on the cable's electrical activity, in real time. This function can be used for monitoring against theft of powered cable, generating an alarm any time the cable is powered down, thus reducing the number of detection boxes (1) necessary for the surveillance of a long cable. Monitoring the electrical activity of a cable can also be beneficial, particularly when thresholds are exceeded at certain times, and requiring, for example, immediate reaction on the site.

Video Surveillance Bus

An advantage is that the system comprises at least one specialised bus able to transfer a mass of analogue or digital data from several video cameras (101) and several audio sources at the same time from one box (1) to another. It is also able to circulate simultaneously at least one flow of digital data at speeds in excess of 1 Mb, at least one audio flow in full duplex, and at least one alarm management channel.

Securing System Power

An advantage is that the boxes (1) can guarantee the security of an overall operation. Each box (1) can be equipped with short circuit protection mechanisms. This protection can be automatically removed when the short circuit has ended and/or manually removed from a remote station (102) and/or on the box (1) and/or nearby. Manual management of this security allows the remote station user (102) to generate technical call-outs by isolating all or part of the video surveillance bus network. The sectioning of a power cable generating a short circuit cannot bring the whole system down, and in the case of manual management on electrical power of dangerous voltage, human intervention from the remote station (102) will be necessary to re-power up the damaged section.

Display of Information

An advantage is that the system allows the user to visualise one or more video and/or audio flows on the remote station (102), as well as one or more physical measurement curves, whilst permanently monitoring the whole of the network. When an alarm is triggered, the remote station (102) generates a visual alarm and displays the video flow and possibly the audio flow attributed to this type of alarm (security, technical) in the form of a window, for example. The alarm is geolocated on the remote station screen (102), on a drawing, a photo or any other format that enables the user to immediately identify the location. In the case of multiple floors, the display can use translucent tabs allowing visualisation at several levels, for example.

Setting of Remote Sensitivity

An advantage is that the system allows remote setting of boxes (1), and this by individual box (1) and/or by blocks of boxes (1) and/or globally. In general terms, all the box functionalities (1) can be set and modified from the remote stations (102).

Taking Control of the System Remotely

An advantage is that each remote station (102) can contain server software allowing other remove stations (102) to take control of the whole of the system via an internet-type computer network, for example.

Central Alarm Unit

An advantage is that the system can be controlled via an internet-type computer system. This benefit means that several systems on several remote sites can be managed from a single central location. A periodic verification system between the video system and/or the anti-intrusion system of this external central unit (ping type) allows the status of the said system, the absence of signal revealing either an attack on the system or a fault, to be identified.

Clearly, the examples given here are only particular illustrations, and under no circumstances exhaustive as to the scope of application of the invention.

1.-10. (canceled)

11. An intrusion attempt detection system for use with a fence of fixed panels on poles, including means of detection of shock and/or vibration and connected to a remote station, the system comprising:
at least one housing having at least one central processing unit connected to at least one memory unit;
at least one shock and/or vibration detector;
and has at least one field bus and/or at least one video bus;
wherein each housing is independently connected to another housing and/or at least one remote station for transmitting at least one computer file generated by the central processing unit when a shock and/or vibration is detected by one of the housings.
